(19) United States
(12) Patent Application Publication
(10) Pub. No.: US 2006/0109616 A1
(43) Pub. Date: May 25, 2006

(54) Back support panel for flat panel display and method of producing same

(75) Inventors: Chung-Te Lee, Hsinchu City (TW); Ching-Kun Lai, Dacun Township (TW)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: AU Optronics Corporation

(21) Appl. No.: 10/993,746

(22) Filed: Nov. 19, 2004

(51) Int. Cl. G06F 1/16

(52) U.S. Cl. 361/681

(57) ABSTRACT

A back support panel for use in a flat panel display is provided by at least two panel sections with each of the panel sections having a generally planar surface. The at least two panel sections are adjacent one another and secured together so their generally planar surfaces are in the same plane to form the back support panel with a generally planar surface. A method of producing the back support panel for use in a flat panel display is also disclosed.

### BACKGROUND OF THE INVENTION

1. Technical Field

The invention concerns a back support panel for a flat panel display and a method of producing such a panel.

2. Description of the Background Art

There are many ways of producing a back support panel for flat panel displays such as liquid crystal displays and plasma displays. It is commonplace to make the back support panel in one piece. However, as the panels become larger and larger, the tooling and machines needed to make one piece back support panels become prohibitively large and expensive. Therefore, it would be advantageous to make the back support panels in multiple pieces and attach the pieces together to form the back support panels.

### SUMMARY OF THE INVENTION

The object of the present invention is to create a novel back support panel for use in a flat panel display.

A further object is to provide such a back support panel which may be readily and economically fabricated and will enjoy a long life in operation.

It has now been found that the foregoing and related objects can be readily attained with the following steps:

(a) providing at least two panel sections, each of the panel sections having a generally planar surface;

(b) arranging the at least two panel sections adjacent one another so their generally planar surfaces are in the same plane; and

(c) securing the at least two panel sections together to form a back support panel with a generally planar surface for use in a flat panel display.

Desirably, portions of adjacent ones of the at least two panel sections are overlapped during the arranging step. Then, during the securing step, the overlapped portions of adjacent ones of the at least two panel sections are secured together. The overlapped portions can be secured together by a method chosen from a group consisting of welding, screwing, riveting and adhesive bonding. The overlapped portions can have a reduced thickness.

According to one embodiment of the invention, the overlapped portions of adjacent ones of the at least two panel sections are tabs and grooves. The tabs and grooves have cooperating apertures therein which are used to secure the at least two panel sections together during the securing step. At least one of the cooperating apertures is threaded to accept at least one screw used to secure the at least two panel sections together during the securing step.

In a further feature of the invention, the at least two panel sections are two end panel sections and a middle panel section. During the arranging step, portions of the two end panel sections are overlapped with portions of the middle panel section. During the securing step, the overlapped portions are secured together.

The invention will be fully understood when reference is made to the following detailed description taken in conjunction with the accompanying drawings.

### BRIEF DESCRIPTION OF THE DRAWINGS

FIG. 1 is an exploded perspective view of back light panel module employing the back support panel of the present invention being used in combination with a liquid crystal display panel and a liquid crystal display front bezel;

FIG. 2 is a front plan view of a first embodiment of the back support panel of the present invention after assembly;

FIG. 3 is a cross-sectional view taken along the 3-3 line of FIG. 2;

FIG. 4 is a cross-sectional view taken along the 4-4 line of FIG. 2;

FIG. 5 is an exploded perspective view of the first embodiment of the back support panel of the present invention prior to assembly;

FIG. 6 is an exploded perspective view of a two piece variation of the first embodiment of the back support panel of the present invention prior to assembly;

FIG. 7 is an exploded perspective view of a second embodiment of the back support panel of the present invention prior to assembly;

FIG. 8 is an enlarged perspective view of a portion of the second embodiment of the back support panel in the circle 8 of FIG. 7;

FIG. 9 is a front plan view of the second embodiment of the back support panel of the present invention after assembly;

FIG. 10 is a cross-sectional view taken along the 10-10 line of FIG. 9;

FIG. 11 is an enlarged cross-sectional view of a portion of FIG. 10 within the circle 11;

FIG. 12 is a cross-sectional view taken along the 12-12 line of FIG. 9; and

FIG. 13 is an exploded perspective view of a two piece variation of the second embodiment of the back support panel of the present invention prior to assembly.

FIG. 14 is perspective view of one of the end sections in the third embodiment of the back support panel of the present invention.

### DETAILED DESCRIPTION OF THE INVENTION

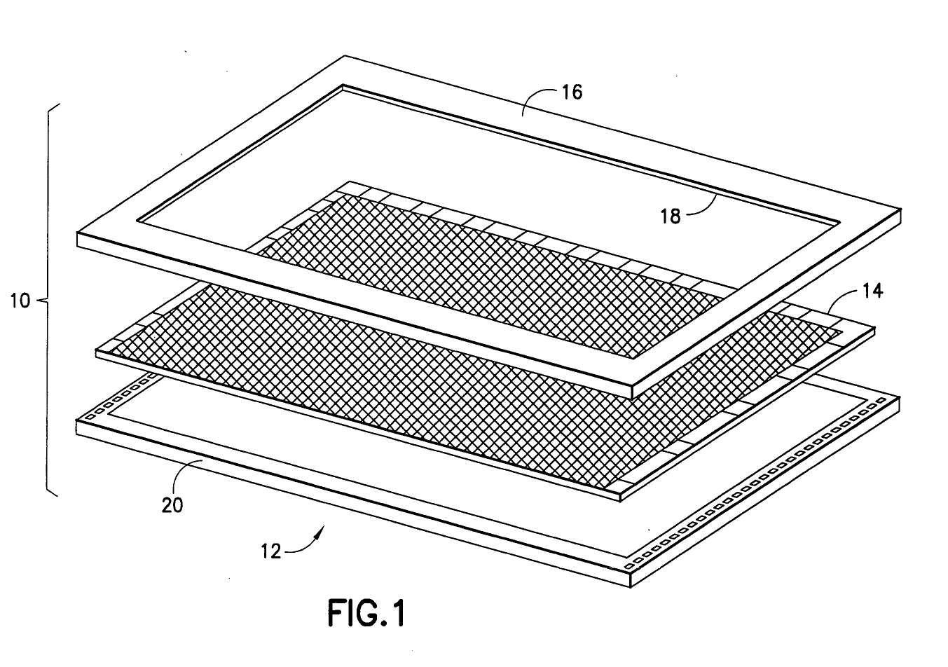

Turning first to FIG. 1 of the drawings, therein illustrated is a flat panel display 10 provided with back light panel module 12, liquid crystal display panel 14 and liquid crystal display front bezel 16. For the purpose of illustration, this invention will be described with reference to a liquid crystal display, but it is applicable to other flat panel displays such as low-temperature polysilicon (LTPS), organic light-emitting diode (OLED), plasma display panel (PDP) and the like.

The liquid crystal display front bezel 16 is a frame with a central opening 18. The central opening 18 is in a rectangular shape and defines the active area for the liquid crystal display panel 14. The liquid crystal display panel 14 can be of the TFT-LCD variety which uses liquid crystal to control the passage of light. The basic structure of a TFT-LCD panel is known by those skilled in the art but may be thought of as two substrates sandwiching a layer of liquid crystal. The front substrate comprises a front electrode layer and a polarizer, while the back substrate has semiconductor components fabricated thereon for controlling the liquid crystal layer. The back substrate also comprises another polarizer.

The back light panel module 12 is located at the back of the liquid crystal display panel 14 and comprises a back-light source therefor in a manner well known in the art.

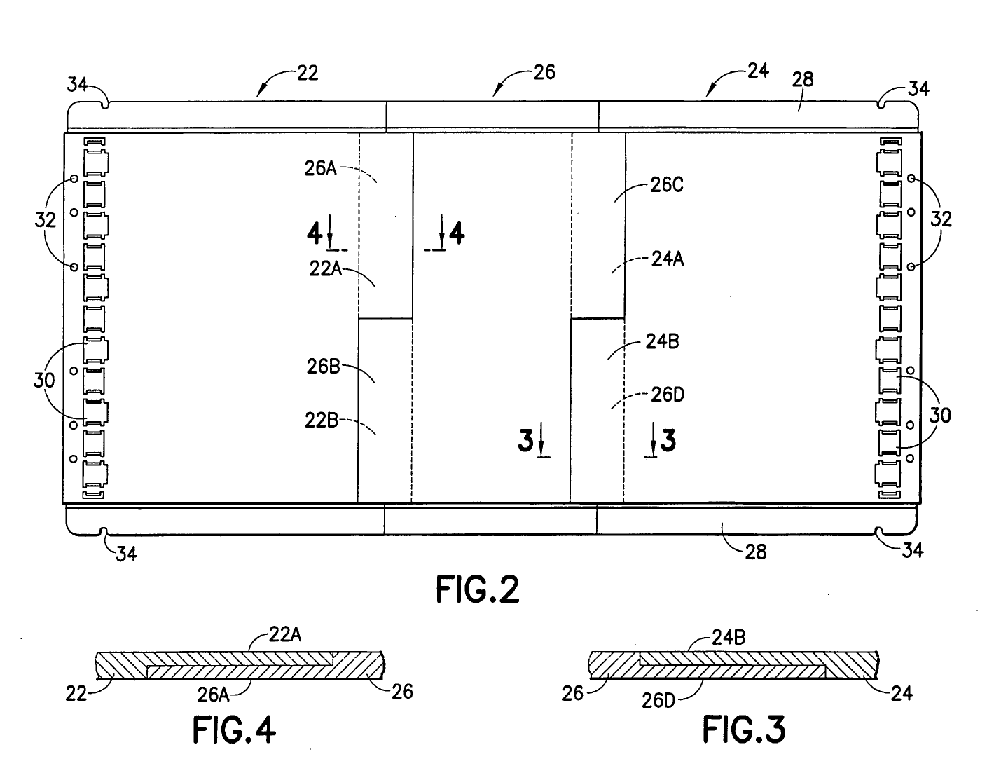

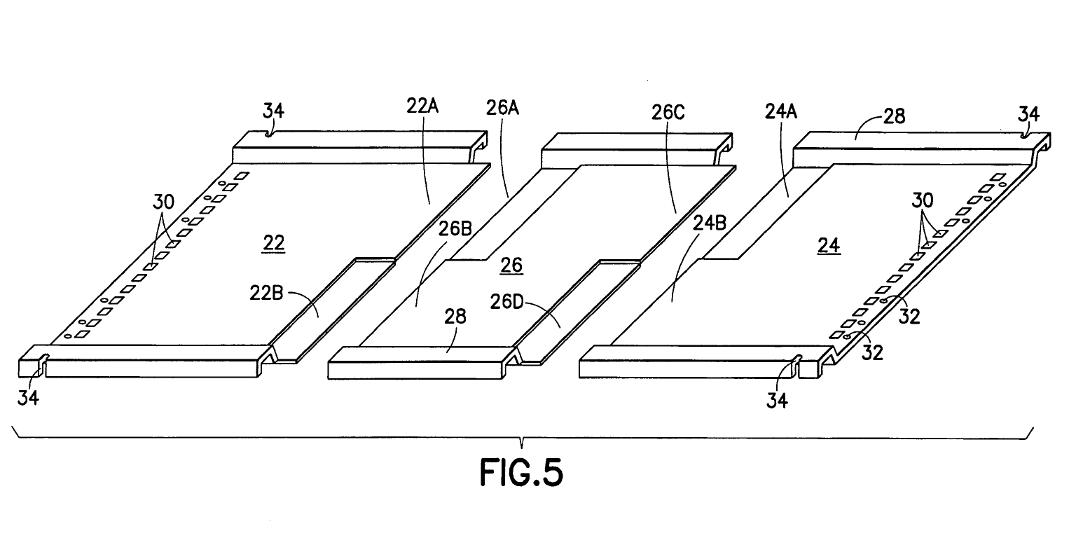

As seen in FIG. 1 and FIG. 2, a major component of the back light panel module 12 is a back support panel 20 upon which all of the various components of the back light panel module 12 are mounted including connectors connected to a power source to power the flat panel display 10. The back support panel 20 is provided by end sections 22, 24 which surround middle section 26. As best seen in FIGS. 2 through 4, the end sections 22, 24 and middle section 26 have areas 22A-B, 24A-B, 26A-D of reduced thickness which are overlapped so as to match the thickness of the remainder of the end sections 22, 24 and middle section 26 to maintain a level surface on both sides of the back support panel 20. As best seen in FIG. 5, the back support panel 20 also has raised channels 28 on the top and bottom thereof. Various keyhole apertures 30, round holes 32 and notches 34 are defined in the ends of the back support panel 20 providing mounting points for the various components of the flat panel display 10 and means to assemble the back light panel module 12 to the liquid crystal display panel 14 and liquid crystal display front bezel 16.

From FIG. 5, it should be clear that the end sections 22, 24 are identical so they can be fashioned from the same tooling in a metal forming press. The top and bottom portions of the middle section 26 are also identical so the middle section 26 is reversible, i.e., reduced thickness areas 26A and 26B can overlap with reduced thickness areas 22A and 22B as well as reduced thickness areas 24B and 24A while reduced thickness areas 26C and 26D can overlap reduced thickness areas 24A and 24B as well as reduced thickness areas 22B and 22A. The reduced thickness areas 22A-B, 24A-B, 26A-D can be milled on a milling machine. The end sections 22, 24 and the middle section 26 can be formed of sheet metal material and are secured to each other by welding, adhesive or other well known securing methods.

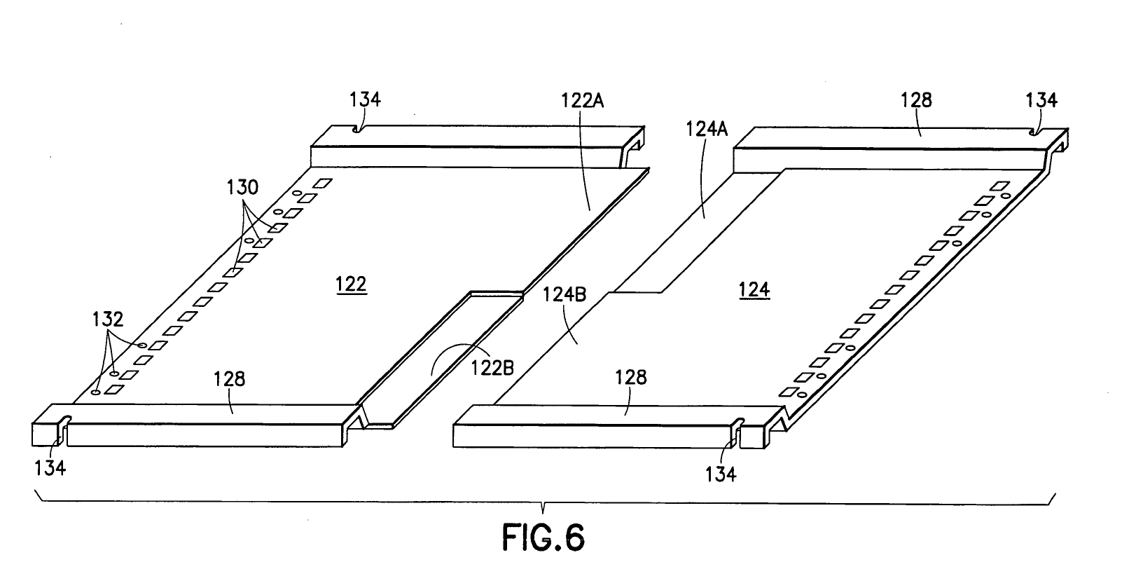

Turning now to FIG. 6, therein is illustrated a two-piece back support panel 120 which is a variation of the three-piece back support panel 20 shown in FIGS. 2 through 5. For ease of explanation, all components of this variation which are similar to the components found in the three-piece back support panel 20 shown in FIGS. 2 through 5 are identified using like references numerals which are increased by 100. The back support panel 120 is provided by end sections 122, 124. The end sections 122, 124 have areas 122A-B, 124A-B of reduced thickness which are overlapped so as to match the thickness of the remainder of the end sections 122, 124 to maintain a level surface on both sides of the back support panel 120. The back support panel 120 also has raised U-shaped channels 128 on the top and bottom thereof. Various keyhole apertures 130, round holes 132 and notches 134 are defined in the ends of the back support panel 120 providing mounting points for the various components of the flat panel display 10 and means to assemble the back light panel module 12 to the liquid crystal display panel 14 and liquid crystal display front bezel 16. The end sections 122, 124 are identical so they can be fashioned from the same tooling in a metal forming press. The reduced thickness areas 122A-B, 124A-B can be milled on a milling machine. The end sections 122, 124 can be formed of sheet metal material and are secured to each other by welding, adhesive or other well known securing methods.

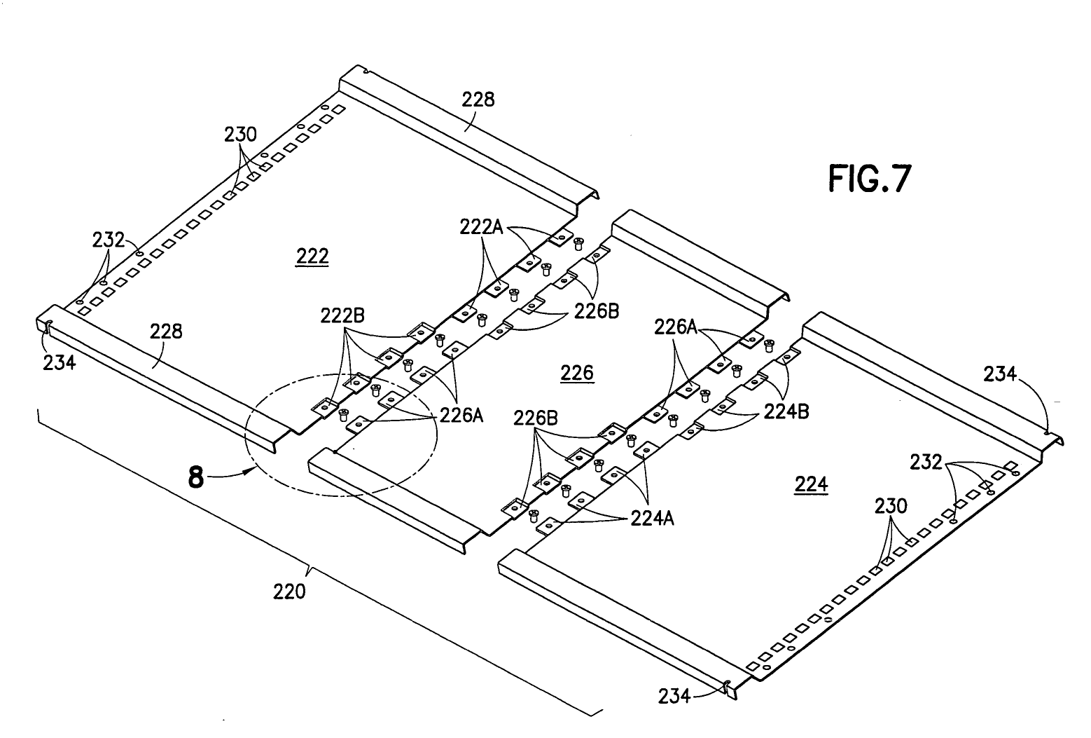

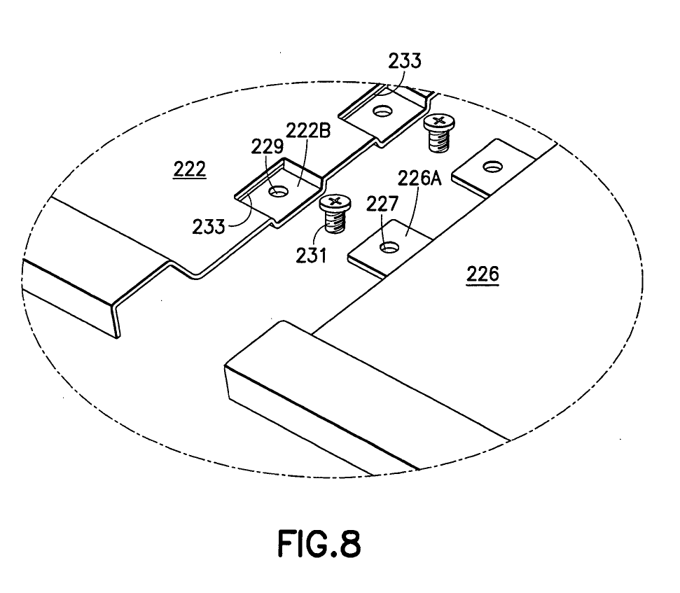

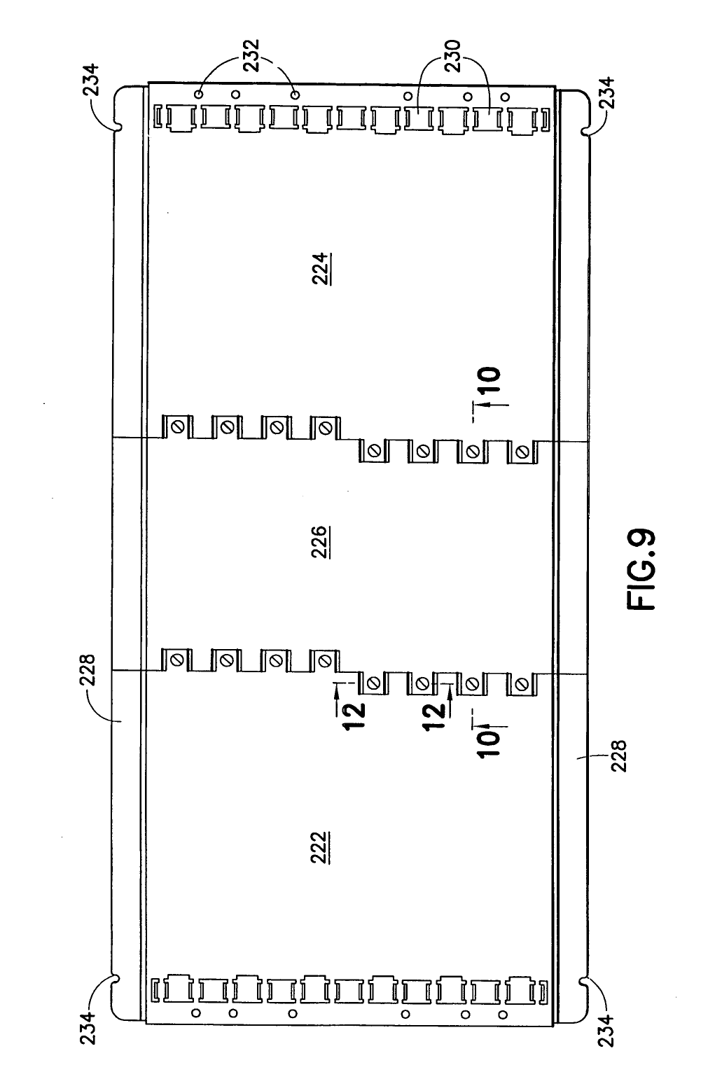

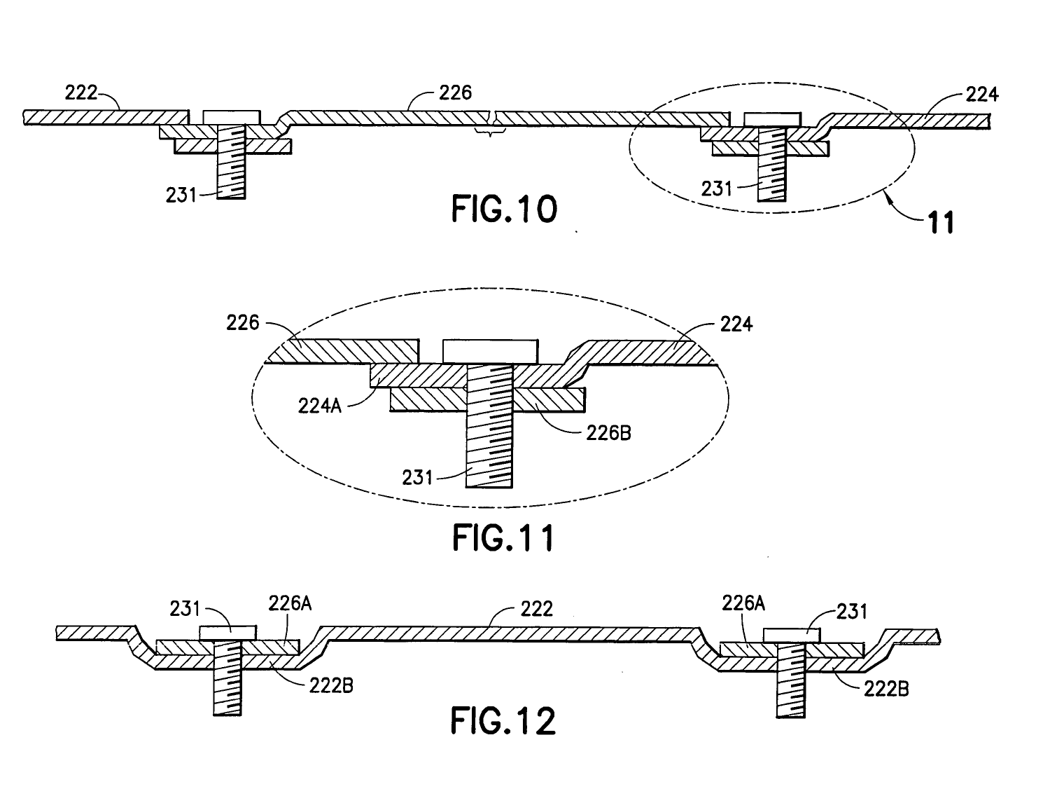

Referring now to FIGS. 7 through 12, a second embodiment of the back support panel 220 of the present invention is shown. The back support panel 220 is provided by end sections 222, 224 which surround a middle section 226. The end sections 222, 224 and middle section 226 have tabs 222A, 224A, 226A and grooves 222B, 224B, 226B which mate as shown in FIGS. 9 through 12. Each of the tabs 222A, 224A, 226A and grooves 222B, 224B, 226B have apertures 227, 229 (FIG. 8) which align when the tabs and grooves are in full mating engagement. The apertures 229 in the grooves 222B, 224B, 226B are threaded to accept screws 231 to hold the end sections 222, 224 and middle section 226 grooves in assembly. It is possible to provide a slot 233 at the end of the grooves 222B (see FIG. 8), 224B, 246B and to make the tabs 222A, 224A, 226A slightly longer than the grooves. As such, when the end sections 222, 224 and the middle section 226 are assembled to complete the back support panel 220, the tip of each tab is inserted into the slot of the corresponding groove in an interlocking position, as shown in FIGS. 10 and 11. Other means for securing the various sections 222, 224, 226 of the back support panel 220 can be used such as welding or riveting.

Like the first embodiment, the back support panel 220 also has raised channels 228 on the top and bottom thereof. Various keyhole apertures 230, round holes 232 and notches 234 are defined in the ends of the back support panel 220 providing mounting points for the various components of the flat panel display 10 and means to assemble the back light panel module 12 to the liquid crystal display panel 14 and liquid crystal display front bezel 16.

The end sections 222, 224 and the middle section 226 can be formed of sheet metal material. The end sections 222, 224 are identical so they can be fashioned from the same tooling in a metal forming press. The top and bottom portions of the middle section 226 are also identical so the middle section 226 is reversible, i.e., the middle section 226 as shown in FIG. 7 can be rotated one hundred eighty degrees (180 degrees) and tabs 222A, 224A, 226A and grooves 222B, 224B, 226B will still mate and apertures 227, 229 will still align.

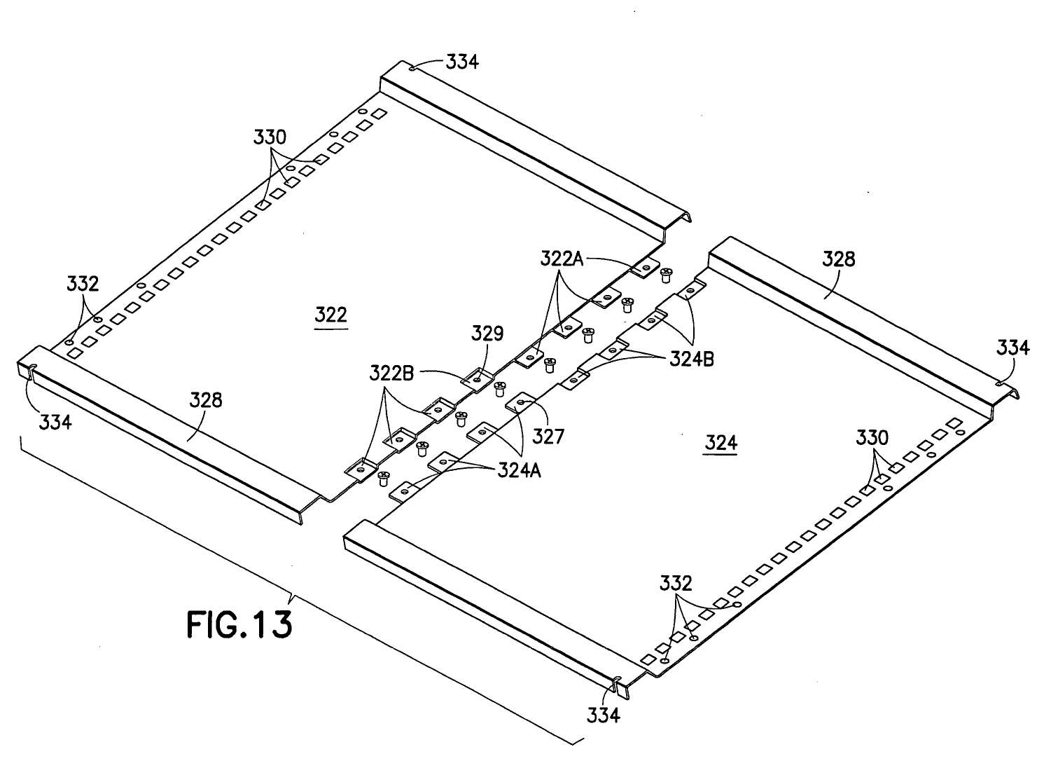

Referring now to FIG. 13, therein is illustrated a two-piece sheet metal back support panel 320 which is a variation of the three-piece back support panel 220 shown in FIGS. 7 through 12. For ease of explanation, all components of this variation which are similar to the components found in the three-piece back support panel 220 shown in FIGS. 7 through 12 are identified using like references numerals which are increased by 100. The back support panel 320 is provided by end sections 322, 324 which have mating tabs 322A, 324A and grooves 322B, 324B. The end sections 322, 324 are identical so they can be fashioned from the same tooling in a metal forming press. Each of the tabs 322A, 324A and grooves 322B, 324B have apertures 327, 329 which align when the tabs and grooves are in full mating engagement. The apertures 329 in the grooves 322B, 324B are threaded to accept screws 331 to hold the end sections 322, 324 in assembly. The back support panel 320 also has raised U-shaped channels 328 on the top and bottom thereof. Various keyhole apertures 330, round holes 332 and notches 334 are defined in the ends of the back support panel 320 providing mounting points for the various components of the flat panel display 10 and means to assemble the back light panel module 12 to the liquid crystal display panel 14 and liquid crystal display front bezel 16.

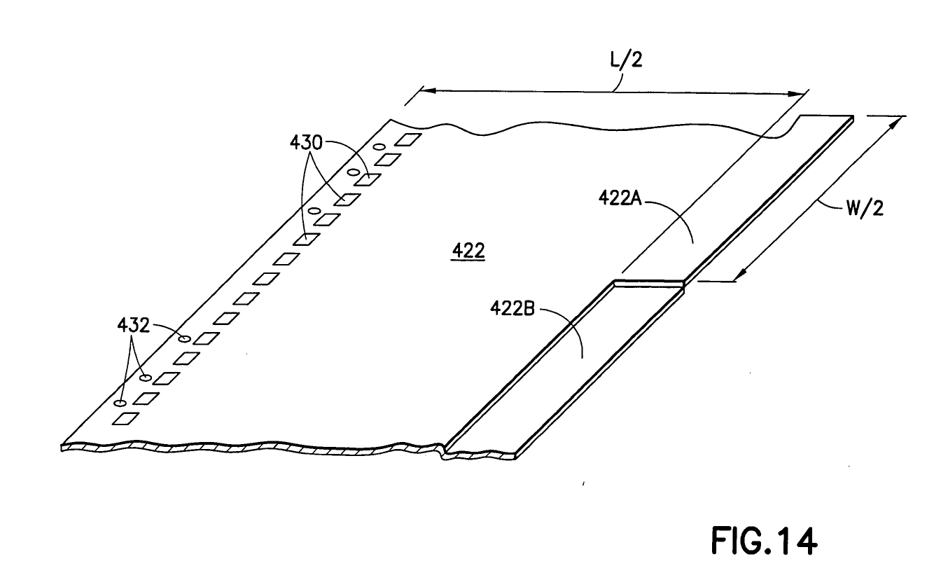

Referring now to FIG. 14, a third embodiment of a two-piece back support panel is shown. This two-piece back support panel has two identical end sections to be joined at their joining ends. Only one of the end sections 422 is shown in FIG. 14. At the joining end of the end section 422, the end section is split into two substantially equal parts 422A and 422B. The part 422B can be stamped, for example, to form a step. Again, various keyhole apertures 430 and round holes 432 are defined for providing mounting points for the various components of the flat panel display 10. If only two end sections 442 are used to complete a back support panel, then the length of the assembled panel will be substantially equal to L. The end sections can be securely attached by welding, spot-welding, for example. The width of the panel is W.

Thus, it can be seen from the foregoing specification and attached drawings that the back support panel of the present invention can be easily constructed using at least two sections. At least two of the sections are identical to one another so they can be constructed from the same tooling.

It should be noted that the flat panel display 10 can also be a plasma display panel (PDP) which also comprises a front bezel 16, a plasma panel 14 and a back panel module 12. The back panel module 12 also has a back support panel 20.

It is believed that the many advantages of this invention will now be apparent to those skilled in the art. It will also be apparent that a number of variations and modifications may be made therein without departing from its spirit and scope. Accordingly, the foregoing description is to be construed as illustrative only, rather than limiting as this invention is limited only by the scope of the following claims.

What is claimed is:

1. A method of producing a back support panel for use in a flat panel display comprising the steps of:
(a) providing at least two panel sections, each of the panel sections having a generally planar surface;
(b) arranging the at least two panel sections adjacent one another so their generally planar surfaces are substantially in the same plane; and
(c) securing the at least two panel sections together to form a back support panel with a generally planar surface for use in a flat panel display.

2. A method as claimed in claim 1, wherein, during the arranging step, portions of adjacent ones of the at least two panel sections are overlapped.

3. A method as claimed in claim 2, wherein, during the securing step, the overlapped portions of adjacent ones of the at least two panel sections are secured together.

4. A method as claimed in claim 3, wherein the overlapped portions are secured together by a method chosen from a group consisting of welding, screwing, riveting and adhesive bonding.

5. A method as claimed in claim 2, wherein the overlapped portions have a reduced thickness.

6. A method as claimed in claim 2, wherein the overlapped portions of adjacent ones of the at least two panel sections are tabs and grooves.

7. A method as claimed in claim 6, wherein the tabs and grooves have cooperating apertures therein which are used to secure the at least two panel sections together during the securing step.

8. A method as claimed in claim 7, wherein at least one of the cooperating apertures is threaded to accept at least one screw used to secure the at least two panel sections together during the securing step.

9. A method as claimed in claim 8, wherein, during the securing step, at least one screw is threaded into the least one of the cooperating apertures which is threaded to secure the at least two panel sections together.

10. A method as claimed in claim 1, wherein the at least two panel sections are two end panel sections and a middle panel section.

11. A method as claimed in claim 10, wherein, during the arranging step, portions of the two end panel sections are overlapped with portions of the middle panel section.

12. A method as claimed in claim 11, wherein, during the securing step, the overlapped portions are secured together.

13. A back support panel for use in a flat panel display comprising:
at least two panel sections, each of the panel sections having a generally planar surface, the at least two panel sections being adjacent one another and secured together so their generally planar surfaces are in the same plane to form the back support panel with a generally planar surface for use in a flat panel display.

14. A back support panel as claimed in claim 13, wherein portions of adjacent ones of the at least two panel sections are overlapped.

15. A back support panel as claimed in claim 14, wherein the overlapped portions of adjacent ones of the at least two panel sections are secured together.

16. A back support panel as claimed in claim 15, wherein the overlapped portions are secured together by a method chosen from a group consisting of welding, screwing, riveting and adhesive bonding.

17. A back support panel as claimed in claim 14, wherein the overlapped portions have a reduced thickness.

18. A back support panel as claimed in claim 14, wherein the overlapped portions of adjacent ones of the at least two panel sections are tabs and grooves.

19. A back support panel as claimed in claim 18, wherein the tabs and grooves have cooperating apertures therein which are used to secure the at least two panel sections together.

20. A back support panel as claimed in claim 19, wherein at least one of the cooperating apertures is threaded and accept at least one screw used to secure the at least two panel sections together.

21. A back support panel as claimed in claim 20, wherein at least one screw is threaded into the least one of the cooperating apertures which is threaded thereby securing the at least two panel sections together.

22. A back support panel as claimed in claim 13, wherein the at least two panel sections are two end panel sections and a middle panel section.

23. A back support panel as claimed in claim 22, wherein portions of the two end panel sections are overlapped with portions of the middle panel section.

24. A back support panel as claimed in claim 23, wherein the overlapped portions are secured together.
